(19) United States
(12) Patent Application Publication
(10) Pub. No.: US 2002/0119763 A1
(43) Pub. Date: Aug. 29, 2002

(54) Smart current system for dynamically varying the operating current of a frequency source in a receiver

(76) Inventors: Balasubramanian Ramachandran, Irvine, CA (US); Aravind Loke, Irvine, CA (US); Trevor Robinson, (US)

Correspondence Address: Francisco A. Rubio-Campos, Sonnenschein Nath & Rosenthal, P.O. Box 061080, Wacker Drive Station, Sears Tower, Chicago, IL, 60606-1080, US

(21) Appl. No.: 09/793,744

(22) Filed: Feb. 26, 2001

(51) Int. Cl. H04B 1/10

(52) U.S. Cl. 455/296; 455/312; 455/1

(57) ABSTRACT

A system capable of varying the operating current of at least one frequency source in the receiver of a communication device in response to the presence of an undesired signal within a frequency band of signals received at the receiver. The system may include a condition signal indicative of the presence of an undesired signal within a frequency band of signals received at a receiver and a controller that adjusts a frequency source responsive to the condition signal.

### BACKGROUND OF THE INVENTION

1. Technical Field

This invention relates to radio frequency transceivers, and, in particular, to a system for varying the operating current of frequency sources within the transceiver.

2. Related Art

In today's society the presence and utilization of telecommunication systems is increasing at a rapid pace. Wireless and broadband systems and infrastructures continue to grow. As a result an increasing number of electronic signals are produced and propagated through an increasingly crowded free-space (i.e., air and space) and guided mediums (i.e., such a wire, cable, microwave, millimeter and optical waveguides utilized by telephone, cable and fiber-optic systems). As the number of propagated electronic signals increases in these crowded mediums so does the probability of signal interference and the need for bandwidth efficiency.

As such, modern communication devices are designed to operate in specific frequency bands in which the communication devices transmit and receive electronic signals at specific predefined frequencies that do not interfere with other communication devices that are transmitting and receiving other electronic signals at other specific predefined frequencies. These designs require that a communication device have an accurate frequency source for accurately demodulating the received electronic signals without also receiving an undesired electronic signal. Typically, the accuracy of the frequency source is designed to achieve high sensitivity performance in the communication device.

Frequency sources are typically non-ideal and are generally characterized by a parameter defined as phase noise. Phase noise quantifies the noise in the frequency source at frequencies other than the frequency of interest. In the presence of strong undesired signals (also known as interfering or jamming signals) within the received band of interest, the phase noise of the frequency source output mixes with the undesired signal and is down-converted to an intermediate frequency (IF) in a super heterodyne implementation of a receiver. The process results in an increase in the in-band noise within the receiver bandwidth and degrades the signal to noise ration (SNR). As such, the current consumption in the typical oscillator core circuits included in a frequency source increases to maintain the phase noise of the frequency source to an adequately low level so as to not degrade the performance of the receiver.

Frequency sources are typically electronic devices that may include a number of components such as transistors, circuits and frequency reference sources such as crystals. These components require power and thus draw significant amounts of current. As a result, a frequency source requires a high amount of power to achieve high accuracy and produce a highly precise frequency output. The power requirement translates into the frequency source drawing high amounts of current for high accuracy.

Unfortunately, energy is expensive and at times in short supply. Modern communication devices such as radios, televisions, stereos and computers consume a significant amount of power that translates into expensive electrical costs. Additionally, current mobile wireless devices such as cellular telephones, portable televisions, portable radios, personal communication devices, pagers and satellites operate on battery power and thus have limited battery time. Limited battery time translates into limited continuous operation time. Therefore, there is a need for a system that reduces the amount of power required by the frequency source of a communication device.

### SUMMARY

This invention provides a receiver capable of varying the operating current of at least one frequency source in the receiver of a communication device in response to the presence of an undesired signal within a frequency band of signals received at the receiver. As an example of operation the system would determine the presence of an undesired signal within a frequency band of signals received at a receiver and adjust a frequency source responsive to the presence of the undesired signal.

As an example implementation of this system architecture, the system may include a condition signal indicative of the presence of an undesired signal within a frequency band of signals received at a receiver and a controller that adjusts a frequency source responsive to the condition signal. The controller, responsive to the presence of the undesired signal, may dynamically adjust the operating current of the frequency source. Additionally, the operating current of the frequency source may be set at a default level optimized for the presence of the undesired signal. The operating current of the frequency source may then be reduced from the default level in the absence of the undesired signal.

Other systems, methods, features and advantages of the invention will be or will become apparent to one with skill in the art upon examination of the following FIGURES. and detailed description. It is intended that all such additional systems, methods features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principals of the invention. In the figures, like reference numerals designate corresponding parts throughout the different views.

FIG. 1 is a block diagram of an example implementation of a Smart Current System “SCS” within a communication device.

FIG. 2 is a block diagram of the transceiver block of the SCS shown in FIG. 1.

FIG. 3 is a plot of signal amplitude versus frequency showing the interference of an undesired signal within the frequency band of received signals at the transceiver block of FIG. 2.

FIG. 4 is a flow chart illustrating the process performed by the SCS of FIG. 1 controlling at least one frequency source.

FIG. 5 is a flow chart illustrating the process performed by the SCS 102 of FIG. 1 in controlling multiple frequency sources.

FIG. 6 is a block diagram of another example implementation of the SCS.

### DETAILED DESCRIPTION OF THE PREFERRED EMBODIMENTS

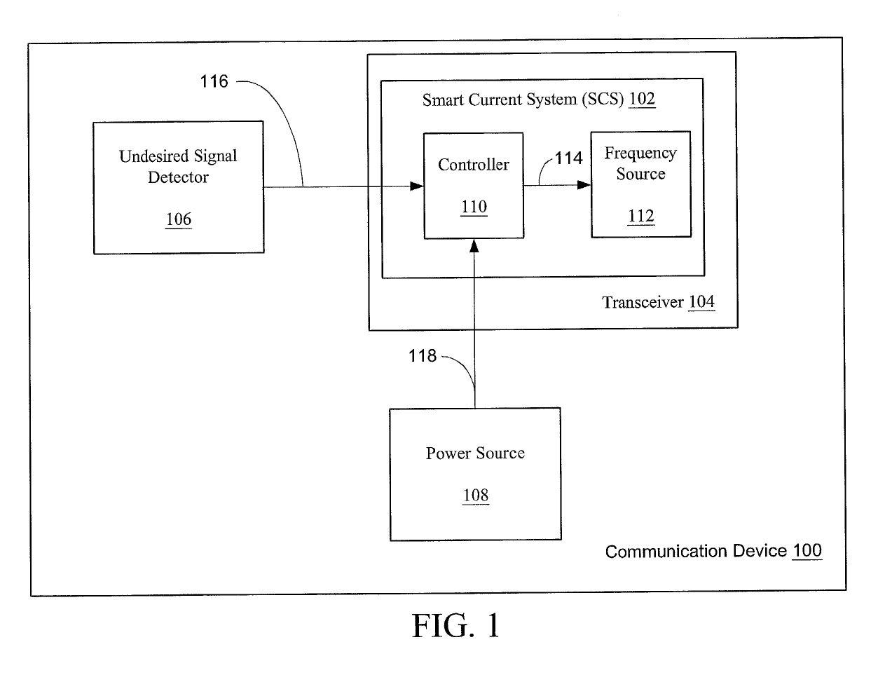

FIG. 1 is a block diagram of a communication device 100. The communication device 100 includes an example implementation of a Smart Current System “SCS” 102 within a transceiver 104, an undesired signal detector 106 and a power source 108. The SCS 102 includes a controller 110 and a frequency source 112. The transceiver 104 is connected to the undesired signal detector 106 and the power source 108. The controller 110 is connected to the frequency source 112, via signal path 114, undesired signal detector 106, via signal path 116, and power source 108 via signal path 118.

The transceiver 104 is a standard type communication device that includes both a receiver (not shown) to receive signals within a first frequency band (i.e., bandwidth), and transmitter (not shown) to transmit other signals within a second frequency band. It is appreciated by those skilled in the art that the first frequency band and second frequency band may be either different frequency bands or the same frequency band based on the desired application of the transceiver 104. The transceiver 104 may be a transceiver in a wireless device (such as a cellular telephone, two-way radio, two-way pager, a satellite, personal digital assistant “PDA” and other personal communication device) or a modem (such as plain old telephone system “POTS,” generic digital subscriber line “XDSL,” cable or fiber optic communication device). Additionally, it is also appreciated, that the SCS 102 may also utilize a receiver (not shown) instead of the transceiver 104. In this case, the receiver may be a receiver in any one-way communication device such as a television, one-way radio, one-way pager, one-way PDA, or other similar device.

The undesired signal detector 106 detects the presence of an undesired signal (also known at times as a “jammer” signal) within the frequency band of signals received at the receiver (not shown) of the transceiver 104 and produces a condition signal indicative of the presence of the undesired signal. The undesired signal detector 106 may be designed for utilization of the SCS 102 in a specific field environment. Typically within a given field environment, the probability function of the occurrence of undesired signals within the frequency band of signals received at the receiver (not shown) indicates that the occurrence of these types of signals are less than continuous. An example of the signal detector 106 in a wireless telephone application includes the Mobile Station Modem integrated circuit produced by Qualcomm Inc., of San Diego, Calif.

The controller 110 is any type of control device that may be selectively implemented in software, hardware (such as a computer, processor, micro controller or the equivalent), or a combination of hardware and software. The controller 110 receives the condition signal from the undesired signal detector 106 via signal path 116. The controller 110 varies and/or adjusts the frequency source 112, via signal path 114, in response to the condition signal from the undesired signal detector 106. The controller 110 may vary and/or adjust the frequency source 112 by varying and/or adjusting a current supplied to the frequency source 112 from the power source 108. As an example, when the controller 110 receives the condition signal indicating the presence of an undesired signal, the controller 110 increases the amount of current supplied from the power source 108 to the frequency source 112 to a current level above a predetermined current level. When the controller 110 later receives the condition signal indicating that there are no more undesired signals, the controller 110 then decreases the amount of current supplied from the power source 108 to the frequency source 112 back to the predetermined current level. Additionally, if the relative strength of the undesired signal relative to the strength of the other received signals is available, the controller 110 may set the amount of current supplied from the power source 108 to the frequency source 112 to a second predetermined current level based on a look up table (not shown) or processor unit (not shown) located either in or external to the controller 110.

As an example implementation in a code division multiple access “CDMA” system, the controller 110 may utilize a total received signal strength indicator (also known as “RSSI”) to measure the total power within the receiver bandwidth. The RSSI produces an output that is generally a combination of the signal, noise and interfering products. However, after demodulation of the received signal by de-spreading operation in the transceiver 104, the signal strength is typically a measure of only the received power only. As such, the relative measure of the undesired signal (i.e., jammer) strength may be obtained by comparing the output of the RSSI with the signal strength after demodulation.

The power source 108 is a standard power supply. In wireless application the power source 108 may be a battery in a cellular telephone or radio. In non-wireless applications the power source 108 may be a power supply connected to a standard power line.

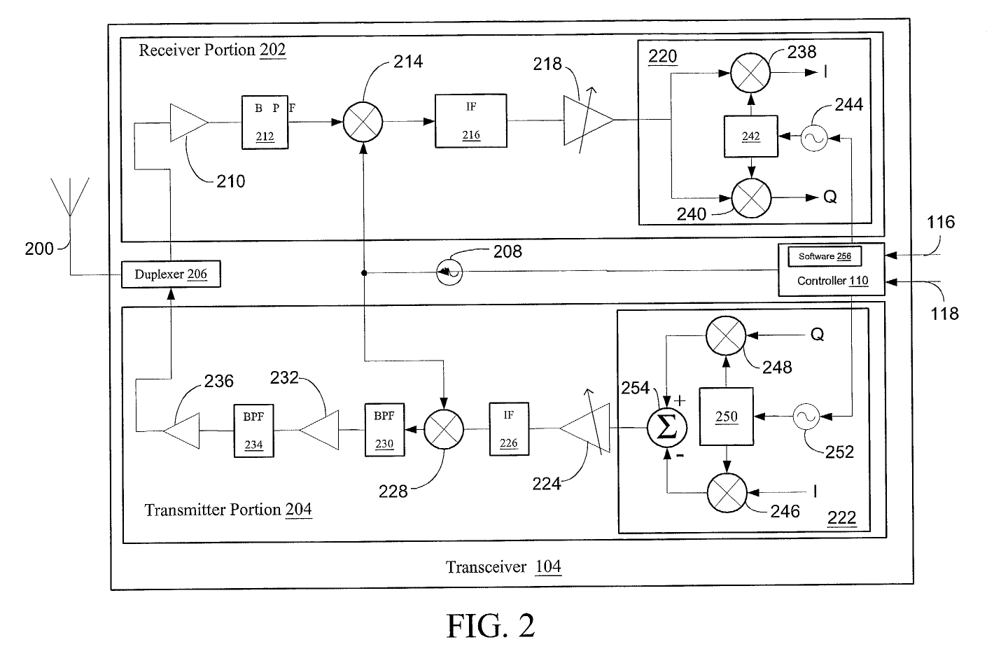

FIG. 2 illustrates an example implementation of a transceiver 104 block shown in FIG. 1 connected to an antenna 200. The transceiver 104 has multiple frequency sources that may be varied, set and/or adjusted by the controller 110. The transceiver 104 includes a receiver portion 202, transmitter portion 204, duplexer 206, a first frequency source 208 and controller 110. The receiver portion 202 and transmitter portion 204 are both electrically connected to the duplexer 206. The duplexer 206 allows simultaneous reception and transmission over antenna 200 by both the receiver portion 202 and transmitter portion 204.

The first frequency source 208 is electrically connected to the controller 110. The first frequency source 208 is a standard frequency device such a local oscillator, frequency synthesizer, or other similar frequency device.

The receiver portion 202 includes a low noise amplifier “LNA” 210, bandpass filter “BPF” 212, mixer 214, intermediate frequency “IF” filter 216, automatic gain control “AGC” amplifier 218, and quadrature demodulator 220. The LNA 210 is electrically connected to the duplexer 206 and BPF 212. The BPF 212 is electrically connected to mixer 214. Mixer 214 is electrically connected to the first frequency source 208 and IF filter 216. The IF filter 216 is electrically connected to AGC 218. The AGC is electrically connected to quadrature demodulator 220. The quadrature demodulator 220 is electrically connected to the controller 110.

The transmitter portion 204 includes a quadrature modulator 222, AGC amplifier 224, IF filter 226, mixer 228, image reject BPF 230, pre-driver amplifier 232, BPF 234 and power amplifier 236. The quadrature modulator 222 is electrically connected to the controller 110 and AGC amplifier 224. The AGC amplifier 224 is electrically connected to IF filter 226. The IF filter 226 is electrically connected to mixer 228. Mixer 228 is electrically connected to both the first frequency source 208 and image reject BPF filter 230. Image reject BPF filter 230 is electrically connected to pre-driver amplifier 232. The pre-driver amplifier 232 is electrically connected to BPF filter 234. BPF filter 234 is electrically connected to power amplifier 236. The power amplifier 236 is electrically connected to duplexer 206.

The quadrature demodulator 220 includes an in-phase (i.e., I channel) mixer 238, out-of-phase (i.e., quadrature “Q” channel) mixer 240, 90° phase shifter 242 and second frequency source 244. The AGC amplifier 218 is electrically connected to both the in-phase mixer 238 and out-of-phase mixer 240. The 90° phase shifter 242 is electrically connected to the in-phase mixer 238, out-of-phase mixer 240 and the second frequency source 244.

The quadrature modulator 222 includes an in-phase mixer 246, out-of-phase mixer 248, 900 phase shifter 250, third frequency source 252 and combiner 254. The AGC amplifier 224 is electrically connected to combiner 254. Combiner 254 is electrically connected to both in-phase mixer 246 and out-of-phase mixer 248. The 90° phase shifter 250 is electrically connected to the in-phase mixer 246, out-of-phase mixer 248 and the third frequency source 252.

In the receiver portion 202, LNA 210 amplifies signals received over antenna 200 and sends the amplified output to BPF 212. BPF 212 rejects all or substantially all signals that are outside the tuning band of the receiver portion 202 (i.e., BPF 212 receives signals within a first frequency band) and passes the signals within the tuning band to mixer 214.

Mixer 214 downconverts (i.e., demodulates) the received signals to intermediate frequencies (such as very high frequency “VHF”), with the first frequency source 208, and sends the downconverted signals to the IF filter 216. The IF filter 216 removes unwanted out-of-band signals that have been downconverted along with the received signal. The IF filter 216 is followed by AGC amplifier 218, which provides a constant or substantially constant input to the quadrature demodulator 220. As an example, the AGC amplifier 218 may accommodate variable received power at the antenna 200 of 90 dB dynamic range. The quadrature demodulator 220 produces a complex baseband signal having I and Q components by downconverting the intermediate signal to baseband utilizing the second frequency source 244, in-phase mixer 238, out-of-phase mixer 240 and 90° phase shifter 242.

In the transmitter portion 204, the quadrature modulator 222 modulates the incoming I and Q components of a complex baseband signal to a VHF intermediate frequency. The modulation is performed by utilizing the third frequency source 252, in-phase mixer 246, out-of-phase mixer 248, 90° phase shifter 250 and combiner 254. The quadrature modulator 222 is followed by the AGC amplifier 224 that provides a linear variable output power at the antenna 200.

The IF filter 226 follows the AGC amplifier 224. The IF filter 226 reduces the out-of-band noise and spurious signals. The IF filter 226 is followed by mixer 228 that modulates the IF signal up to the desired transmit frequency (i.e., a second frequency band), such as ultra high frequency “UIF” or radio frequency “RF” utilizing the first frequency source 208. The output from mixer 228 is processed by image reject BPF 230. The BPF 230 rejects the image frequency (such as higher order harmonics) from the signal output from mixer 208, and passes or substantially passes the entire range of transmit frequencies.

The pre-driver amplifier 232 follows the image reject BPF 230. The pre-driver amplifier 232 boosts the level of the transmit signal from the image reject BPF 230 to a level high enough to drive the power amplifier 236. The BPF 234 follows the pre-driver amplifier 232. The BPF 234 passes the entire range or substantially the entire range of transmit frequencies, but attenuates harmonic frequencies generated by the pre-driver amplifier 232. The BPF 234 is configured to have low loss at transmit frequencies, but high attenuation at harmonic frequencies. As an example, the BPF 234 may be a ceramic or surface acoustic wave “SAW” filter. The power amplifier 236 follows the BPF 234. The power amplifier 236 boosts the level of the transmit signal to the desired output power and sends the signal to the antenna 200 via the duplexer 206.

The undesired signal detector 106, FIG. 1, monitors the received signals at the output of the receiver chain after demodulation, via signal path 238 to detect if an undesired signal is present in the received frequency band at the receiver portion 202. The undesired signal detector 106, FIG. 1, outputs a conditional signal indicative of the presence of an undesired signal within the frequency band of signals received at the receiver portion 202. The conditional signal is input to the controller 110 via signal path 116. The controller 110 responsive to whether an undesired signal is present dynamically varies, sets or adjusts the current from the power source 108, FIG. 1, via signal path 118, for the first frequency source 208, FIG. 2, second frequency source 244 and third frequency source 252.

The frequency sources in this example implementation, including the first frequency source 208, second frequency source 244 and third frequency source 252 are typically implemented in the form of voltage controlled oscillators “VCOs”. Additionally, the operating current for each of the first frequency source 208, second frequency source 244 and third frequency source 252 may be separately set or adjusted by controller 110 because of the different phase noise requirements of each of these frequency sources.

As an example, the phase noise requirement for the first frequency source 208 is typically more stringent than that for the second frequency source 244 because second frequency source 244, unlike the first frequency source 208, is downstream from the IF filter 216, and the IF filter 216 helps attenuate any undesired signals that are present before the undesired signals are able to mix with the frequency reference signal from the second frequency source 244. Additionally, since third frequency source 252 is part of the transmitter portion 204 of the transceiver 106, the need to maintain a low phase noise to eliminate an in-band undesired signal is not present. Moreover, the phase noise requirement is dominated by the adjacent channel power ratio “ACPR” specification, which is less stringent than that imposed on the frequency sources in the receiver portion 202. As another example, in a wireless CDMA system, the ACPR specification typically imposes a phase requirement of about −98 dBc/Hz whereas the phase noise requirement for a local oscillator in the receiver portion may be −138 dBc/Hz.

However, it is appreciated that alternative implementations are possible in which some or all of the frequency sources are dynamically adjusted together, and in which only one or some or all of the frequency sources in the transceiver 104 are dynamically adjusted responsive to the presence of an undesired signal. In another example implementation, only the operating current for first frequency source 208 is dynamically adjusted responsive to the presence of an undesired signal. In still another example implementation, only the operating currents for the first frequency source 208 and second frequency source 244 are dynamically adjusted responsive to the presence of an undesired signal. Also, additional implementations are possible in where the controller 110 is embodied in the form of hardware (such as a digital signal processing “DSP” chip or application specific integrated circuit “ASIC”) or via software 256 embedded in the controller 110.

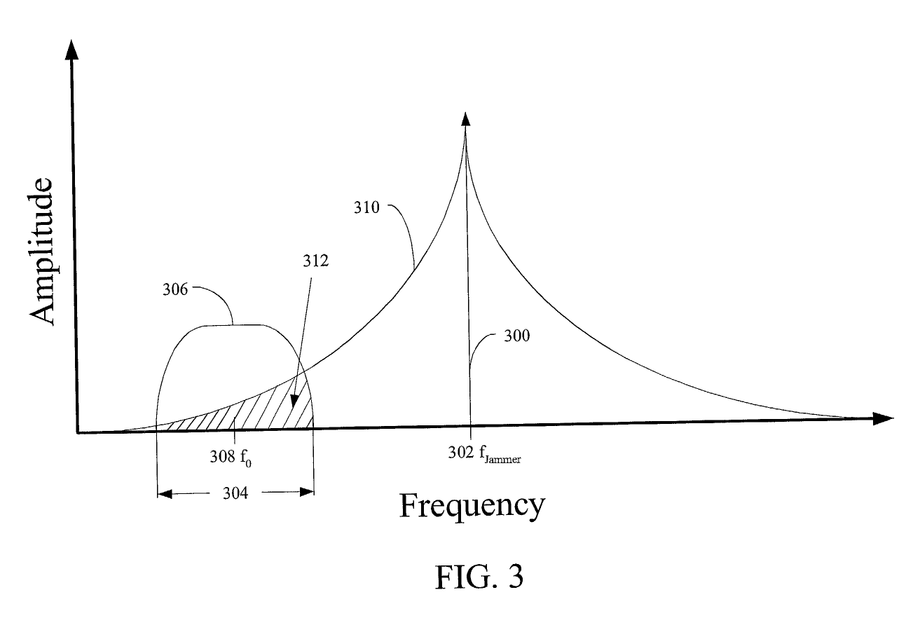

FIG. 3 is a plot of signal amplitude versus frequency showing the interference effect of an undesired signal 300 (also known as a jammer signal) at frequency “fⱼₐₘₘₑᵣ” 302 within the frequency band 304 of received signals 306 at the transceiver 104, FIG. 2. Frequency band 304, FIG. 3, illustrates the frequency band of received signals 306 at the transceiver 104, FIG. 2 centered on a desired received signal at frequency “f₀” 308. The undesired signal 300 is shown at a frequency 302 above the desired received signal frequency 308. The frequency envelope 310 from the undesired signal 300 is shown overlapping 312 and interfering within the frequency band 304 of received signals 306 at the transceiver 104, FIG. 1.

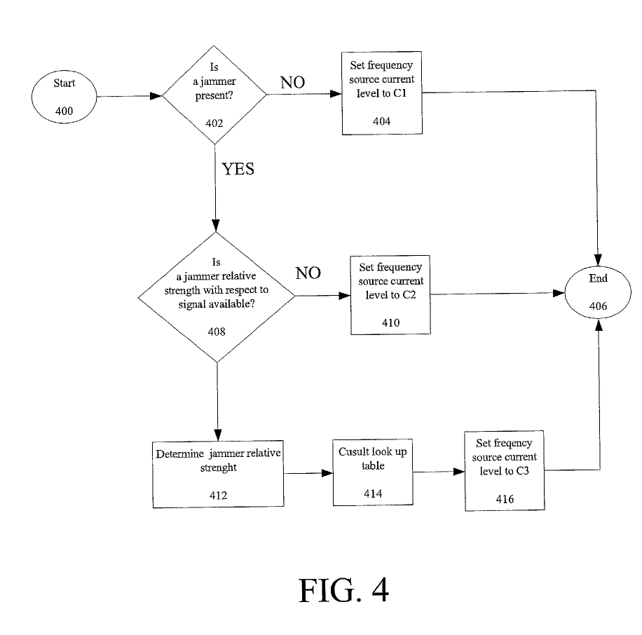

FIG. 4 is a flow chart of an example process performed by the SCS 102 of FIG. 1 in controlling at least one frequency source 112. The process begins in step 400, FIG. 4, and continues to decision step 402. In step 400, the transceiver 104, FIG. 1, receives a frequency band of signals received at the receiver portion 202, FIG. 2, of the transceiver 104 and the undesired signal detector 106, FIG. 1, produces a condition signal indicative of the presence of an undesired signal within the frequency band of signals received at a receiver portion 202, FIG. 2. In decision step 402, FIG. 4, the SCS 102, FIG. 1, then receives the condition signal, via signal path 116, and determines the presence of an undesired signal within the frequency band of signals received at a receiver portion 202, FIG. 2, with the controller 110. If the SCS 102, FIG. 1, determines that there is no undesired signal present, the process continues to step 404, FIG. 4. In step 404, the controller 110, FIG. 1, sets the amount of current supplied to at least one frequency source 112 in the transceiver 104, by the power source 108, to a predetermined current level “C1” and the process ends in step 406, FIG. 4.

If instead the SCS 102, FIG. 1, determines that there is an undesired signal present, the process continues to decision step 408. In decision step 408, the SCS 102, FIG. 1, determines whether the relative strength of the undesired signal with respect to the other received signals at the transceiver 104 is available with the controller 11( ). If the SCS 102 determines that the relative strength is not available the process continues to step 410, FIG. 4. In step 410, the controller 110, FIG. 1, sets the amount of current supplied to at least one frequency source 112, by the power source 108, to a second current level “C2” above C1 and the process ends in step 406, FIG. 4.

If instead the SCS 102, FIG. 1, determines that the relative strength is available, the process continues to step 412, FIG. 4. In step 412, the controller 110, FIG. 1, determines the relative strength and utilizes a lookup table or processor unit, in step 414, to determine a third current level “C3” above C1 to supply to the at least one frequency source 112. The process then continues to step 416, FIG. 4. In step 416, the controller 110, FIG. 1, sets the amount of current supplied to the at least one frequency source 112, by the power source 108, to C3 and the process ends in step 406, FIG. 4.

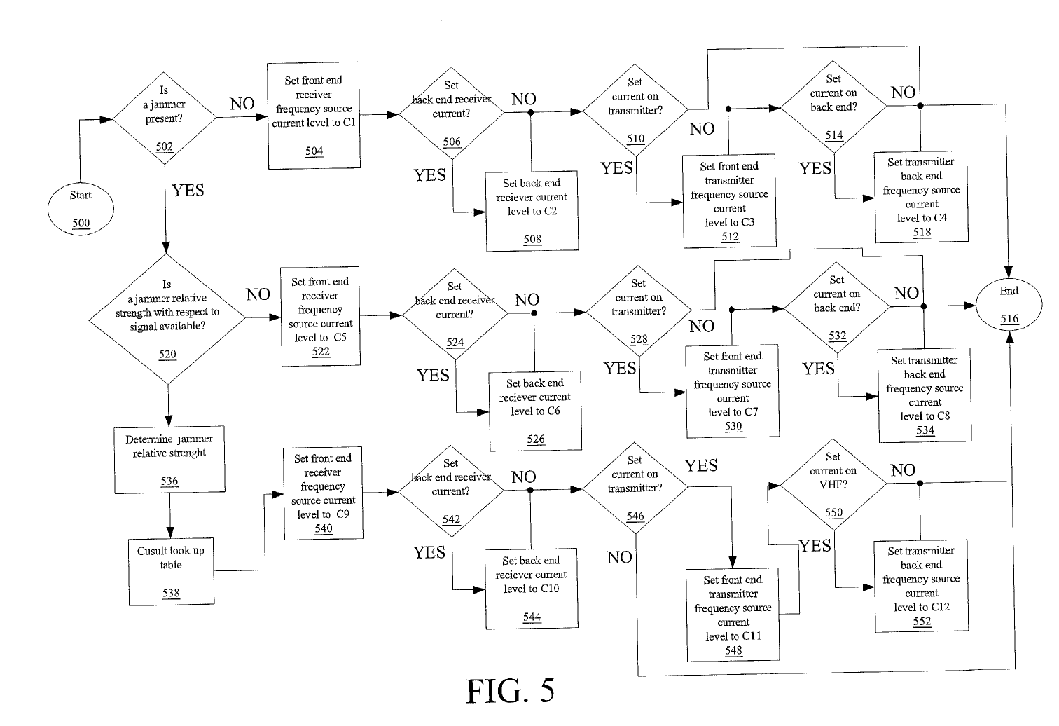

FIG. 5 is a flow chart of an example process performed by the SCS 102 of FIG. 1 in controlling multiple frequency sources. The process begins in step 500, FIG. 5, and continues to decision step 502. In step 500, the transceiver 104, FIG. 1, receives a frequency band of signals received at the receiver portion 202, FIG. 2, of the transceiver 104, FIG. 2, and the undesired signal detector 106, FIG. 1, produces a condition signal indicative of the presence of an undesired signal within the frequency band of signals received at a receiver portion 202, FIG. 2. In decision step 502, FIG. 5, the SCS 102, FIG. 1, then receives the condition signal, via signal path 116, and determines the presence of an undesired signal within the frequency band of signals received at a receiver portion 202, FIG. 2, with the controller 110. If the SCS 102, FIG. 1, determines that there is no undesired signal present, the process continues to step 504, FIG. 5. In step 504, the controller 110, FIG. 1, sets the amount of current supplied by the power source 108 to the front end frequency source 208, FIG. 2, in the receiver portion 202 of the transceiver 104 to a predetermined current level “C1” and the process continues to decision step 506, FIG. 5. In decision step 506, the controller 110, FIG. 1, determines whether to set the back end frequency source 244, FIG. 2, in the receiver portion 202. If the controller 110 decides to set the back end frequency source 244, the process continues to step 508, FIG. 5, and the controller 110, FIG. 1, sets back end frequency source 244, FIG. 2, to a second predetermined current level “C2” and the process continues to decision step 510, FIG. 5. If instead the controller 110, FIG. 1, decides not to set the back end frequency source 244, FIG. 2, the process continues to decision step 510, FIG. 5.

In decision step 510, the controller 110, FIG. 1, determines whether to set the current on the frequency sources in the transmitter portion 204, FIG. 2. If the controller 110 decides to set the transmitter portion 204 frequency sources, the process continues to step 512, FIG. 5, and the controller 110 sets the front end frequency source 208 to a third predetermined current level “C3” and the process continues to decision step 514, FIG. 5. If instead the controller 110, FIG. 1, decides not to set the frequency sources in the transmitter portion 204, FIG. 2, the process ends in step 516, FIG. 5.

In decision step 514, the controller 110, FIG. 1, determines whether to set the current on the back end frequency source 252, FIG. 2, in the transmitter portion 204. If the controller 110 decides to set the transmitter portion 204 back end frequency source 252, the process continues to step 518, FIG. 5, and the controller 110 sets the back end frequency source 252 to a fourth predetermined current level “C4” and the process ends in step 516, FIG. 5. If instead the controller 110, FIG. 1, decides not to set the back end frequency source 252, FIG. 2, the process ends in step 516, FIG. 5.

If in decision step 502 the SCS 102, FIG. 1, determines that there is an undesired signal present, the process continues to decision step 520, FIG. 5. In decision step 520, the SCS 102, FIG. 1, determines with the controller 110 whether the relative strength of the undesired signal with respect to the other received signals at the transceiver 104 is available. If the SCS 102 determines that the relative strength is not available the process continues to step 522, FIG. 5. In step 522, the controller 110, FIG. 1, sets the amount of current supplied by the power source 108 to the front end frequency source 208, FIG. 2, in the receiver portion 202 of the transceiver 104 to a current level “C5” above C1 and the process continues to decision step 524, FIG. 5. In decision step 524, the controller 110, FIG. 1, determines whether to set the back end frequency source 244, FIG. 2, in the receiver portion 202. If the controller 110 decides to set the back end frequency source 244, the process continues to step 526, FIG. 5, and the controller 110, FIG. 1, sets back end frequency source 244, FIG. 2, to a current level “C6” above C2 and the process continues to decision step 528, FIG. 5. If instead the controller 110, FIG. 1, decides not to set the back end frequency source 244, FIG. 2, the process continues to decision step 528, FIG. 5.

In decision step 528, the controller 110, FIG. 1, determines whether to set the current on the frequency sources in the transmitter portion 204, FIG. 2. If the controller 110 decides to set the transmitter portion 204 frequency sources, the process continues to step 530, FIG. 5, and the controller 110 sets the front end frequency source 208 to a current level “C7” above C3 and the process continues to decision step 532, FIG. 5. If instead the controller 110, FIG. 1, decides not to set the frequency sources in the transmitter portion 204, FIG. 2, the process ends in step 516, FIG. 5.

In decision step 532, the controller 110, FIG. 1, determines whether to set the current on the back end frequency source 252, FIG. 2, in the transmitter portion 204. If the controller 110 decides to set the transmitter portion 204 back end frequency source 252, the process continues to step 534, FIG. 5, and the controller 110 sets the back end frequency source 252 to a current level “C8” above C4 and the process ends in step 516, FIG. 5. If instead the controller 110, FIG. 1, decides not to set the back end frequency source 252, FIG. 2, the process ends in step 516, FIG. 5.

If instead the SCS 102, FIG. 1, in decision step 520, FIG. 5, determines that the relative strength is available, the process continues to step 536. In step 536, the controller 110, FIG. 1, determines the relative strength and utilizes a lookup table or processor unit, in step 538, to determine a current level “C9” above C1 to supply to the front end frequency source 208, FIG. 2 of the receiver portion 202 of the transceiver 104. The process then continues to step 540, FIG. 5. In step 540 the controller 110, FIG. 1, sets the amount of current supplied by the power source 108 to the front end frequency source 208, FIG. 2, to a current level “C9” above C1 from the lookup table or processor unit and the process continues to decision step 542, FIG. 5. In decision step 542, the controller 110, FIG. 1, determines whether to set the back end frequency source 244, FIG. 2, in the receiver portion 202. If the controller 110 decides to set the back end frequency source 244, the process continues to step 544, FIG. 5, and the controller 110, FIG. 1, sets the back end frequency source 244, FIG. 2, to a current level “C10” above C2 from the lookup table or processor unit and the process continues to decision step 546, FIG. 5. If instead the controller 110, FIG. 1, decides not to set the back end frequency source 244, FIG. 2, the process continues to decision step 546, FIG. 5.

In decision step 546, the controller 110, FIG. 1, determines whether to set the current on the frequency sources in the transmitter portion 204, FIG. 2. If the controller 110 decides to set the transmitter portion 204 frequency sources, the process continues to step 548, FIG. 5, and the controller 110 sets the front end frequency source 208 to a current level “C11” above C3 from the lookup table or processor unit and the process continues to decision step 550, FIG. 5. If instead the controller 110, FIG. 1, decides not to set the frequency sources in the transmitter portion 204, FIG. 2, the process ends in step 516, FIG. 5.

In decision step 550, the controller 110, FIG. 1, determines whether to set the current on the back end frequency source 252, FIG. 2, in the transmitter portion 204. If the controller 110 decides to set the transmitter portion 204 back end frequency source 252, the process continues to step 552, FIG. 5, and the controller 110 sets the back end frequency source 252 to a current level “C12” above C4 from the lookup table or processor unit and the process ends in step 516, FIG. 5. If instead the controller 110, FIG. 1, decides not to set the back end frequency source 252, FIG. 2, the process ends in step 516, FIG. 5.

It is appreciated that the controller 110, FIG. 1, may be selectively implemented in software, hardware, or a combination of hardware and software. For example, the elements of the controller 110 may be implemented in software 258, FIG. 2, stored in a memory located in a controller 110. The software 258 configures and drives the controller 110 and performs the processes illustrated in FIG. 4 and FIG. 5.

The software 258 includes an ordered listing of executable instructions for implementing logical functions. The software 258 may be embodied in any computer-readable medium, or computer bearing medium, for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” is any means that may contain, store, communicate, propagate, or transport the program for use by or in connection with the instruction execution system, apparatus, or device. The computer readable medium may be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM (electronic), a read-only memory “ROM” (electronic), an erasable programmable read-only memory (EPROM or Flash memory) (electronic), an optical fiber (optical), and a portable compact disc read-only memory “CDROM” (optical).

An example implementation of the processes described in FIG. 4 and FIG. 5 may employ at least one computer-readable signal bearing medium (such as the internet, magnetic storage medium, such as floppy disks, or optical storage, such as compact disk (CD/DVD), biological, or atomic data storage medium). In yet another example implementation, the computer-readable signal-bearing medium comprises a modulated carrier signal transmitted over a network comprising or coupled with a diversity receiver apparatus, for instance, one or more telephone networks, a local area network, the Internet, and wireless network. An exemplary component of such embodiments is a series of computer instructions written in or implemented with any number of programming languages. Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

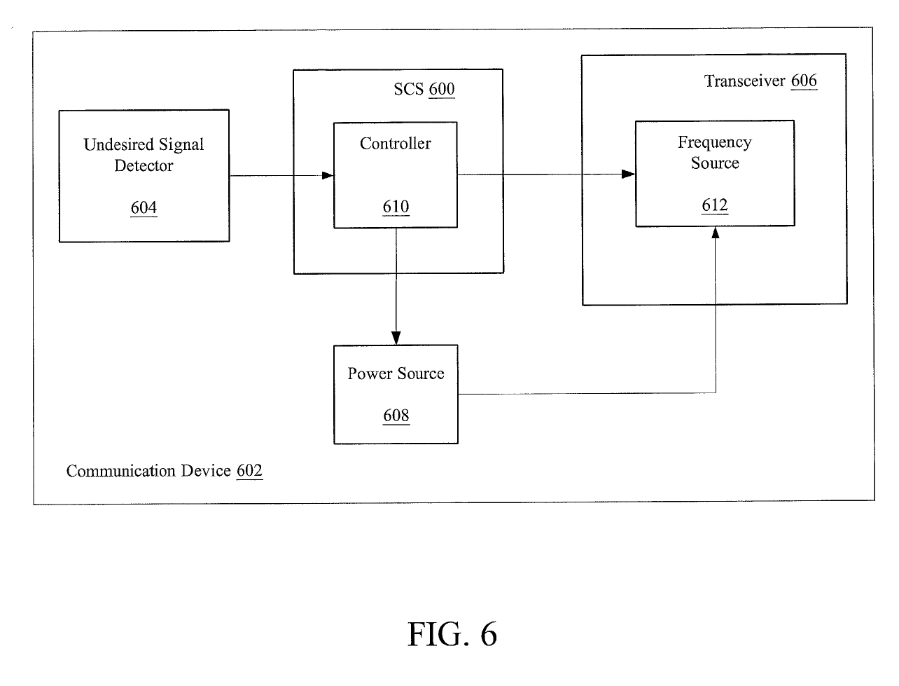

FIG. 6 is a block diagram of another example implementation of a SCS 600 within a communication device 602. The communication device 602 includes the SCS 600, an undesired signal detector 604, a transceiver 606 and a power source 608. The SCS includes a controller 610 and the transceiver 606 includes a frequency source 612. In this example implementation the SCS 600 is electrically connected to the undesired signal detector 604 and the power source 608. The SCS 600 is also electrically connected externally to the transceiver 606.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A system comprising:
a condition signal indicative of the presence of an undesired signal within a frequency band of signals received at a receiver; and
a controller that adjusts a frequency source responsive to the condition signal.

2. The system of claim 1 wherein the controller adjusts an operating current of the frequency source.

3. The system of claim 2 wherein the frequency source is an oscillator.

4. The system of claim 2 wherein the operating current of the frequency source is dynamically adjusted by the controller responsive to the presence of the undesired signal.

5. The system of claim 4 wherein the operating current of the frequency source is set at a default level optimized for the presence of the undesired signal.

6. The system of claim 5 wherein the operating current of the frequency source is reduced from the default level for the absence of the undesired signal.

7. The system of claim 1 wherein the receiver is part of a transceiver.

8. The system of claim 7 wherein the transceiver includes a transmitter portion, and an operating current of another frequency source in the transmitter portion is dynamically adjusted responsive to the presence of the undesired signal.

9. The system of claim 8 wherein the operating current of the other frequency source is set at a default level optimized for the presence of the undesired signal.

10. The system of claim 9 wherein the operating current of the other frequency source is reduced from the default level for the absence of the undesired signal.

11. The system of claim 8 wherein the transceiver is a spread spectrum transceiver.

12. The system of claim 8 wherein the transceiver is a time domain multiple access transceiver.

13. The system of claim 8 wherein the transceiver is an analog modulation transceiver.

14. The system of claim 12 wherein the transceiver is a frequency modulation (FM) transceiver.

15. The system of claim 1 wherein the receiver includes a superheterodyne receiver having a ultra-high frequency (UHF) frequency source, and an operating current of the UHF frequency source is dynamically adjusted responsive to the presence of the undesired signal.

16. The system of claim 15 wherein the superheterodyne receiver also has a very-high frequency (VHF) frequency source, the operating current of the VHF frequency source is dynamically adjusted responsive to the presence of the undesired signal.

17. The system of claim 1 wherein the receiver is in a wireless communication device.

18. The system of claim 1 wherein the controller varies a plurality of frequency sources responsive to the condition signal.

19. The system of claim 18 wherein the controller varies the operating currents of the plurality of frequency sources.

20. The system of claim 19 wherein each frequency source of the plurality of frequency sources is an oscillator.

21. The system of claim 19 wherein the operating currents of the plurality of frequency sources are dynamically varied by the controller responsive to the presence of the undesired signal.

22. The system of claim 21 wherein the operating current of the plurality of frequency sources is set at a default level optimized for the presence of the undesired signal.

23. The system of claim 22 wherein the operating current of the plurality of frequency source is reduced from the default level for the absence of the undesired signal.

24. The system of claim 18 wherein the controller varies the operating current for the plurality of frequency sources separately.

25. A system comprising:
a condition signal indicative of the presence of an undesired signal within a frequency band of signals received at a receiver having a front-end and a back-end; and
a controller that varies a frequency source responsive to the condition signal.

26. The system of claim 25 wherein the frequency source is connected via a signal path to the front-end of the receiver.

27. The system of claim 26 wherein the frequency source is an oscillator.

28. The system of claim 26 wherein the frequency source is connected by the signal path to a mixer in the front-end of the receiver.

29. The system of claim 28 wherein the frequency source is an oscillator.

30. The system of claim 25 wherein the receiver is part of a transceiver.

31. The system of claim 30 wherein the transceiver includes a transmitter portion, and the frequency source is connected by a second signal path to the transmitter portion.

32. The system of claim 31 wherein the transmitter portion has a front-end and a back-end and the frequency source is connected by the second signal path to the front-end of the transmitter portion.

33. The system of claim 32 wherein the frequency source is connected by the signal path to a mixer in the front-end of the transmitter portion.

34. The system of claim 33 wherein the frequency source is an oscillator.

35. The system of claim 25 wherein the frequency source is connected by a signal path to the back-end of the receiver.

36. The system of claim 35 wherein the frequency source is an oscillator.

37. The system of claim 35 wherein the frequency source is connected by a signal path to a mixer in the back-end of the receiver.

38. The system of claim 37 wherein the frequency source is an oscillator.

39. The system of claim 25 wherein the receiver is part of a transceiver.

40. The system of claim 39 wherein the transceiver includes a transmitter portion, and the frequency source is connected by a second signal path to the transmitter portion.

41. The system of claim 40 wherein the transmitter portion has a front-end and a back-end, and the frequency source is connected by the second signal path to the back-end of the transmitter.

42. The system of claim 41 wherein the frequency source is connected by the signal path to a mixer in the back-end of the transmitter.

43. The system of claim 42 wherein the frequency source is an oscillator.

44. A method comprising:
determining the presence of an undesired signal within a frequency band of signals received at a receiver; and
adjusting a frequency source responsive to the presence of the undesired signal.

45. The method of claim 44 wherein the step of varying further includes varying an operating current of the frequency source.

46. The method of claim 45 wherein the frequency source is an oscillator.

47. The method of claim 45 wherein the varying the operating current is dynamic.

48. The method of claim 47 further including:
setting the operating current of the frequency source to a default level optimized for the presence of the undesired signal; and
reducing the operating current upon determining the absence of the undesired signal.

49. The method of claim 44 wherein the receiver is part of a transceiver.

50. The method of claim 49 further comprising dynamically adjusting the operating current of at least one local oscillator in the receiver.

51. The method of claim 44 further comprising dynamically adjusting the operating current of the frequency source in a transmitter portion of the transceiver responsive to the presence of the undesired signal.

52. The method of claim 44 further comprising dynamically adjusting the operating current of a VHF local oscillator in a superheterodyne receiver responsive to the presence of the undesired signal.

53. The method of claim 44 further comprising dynamically adjusting the operating current of a UHF local oscillator in a superheterodyne receiver responsive to the presence of the undesired signal.

54. The method of claim 44 further including varying a plurality of frequency sources responsive to the presence of the undesired signal.

55. The method of claim 54 wherein the step of varying includes separately varying the operating currents of the plurality of frequency sources responsive to the presence of the undesired signal.

56. The method of claim 55 wherein the receiver is part of a transceiver.
